(19) United States
(12) Patent Application Publication
(10) Pub. No.: US 2026/0341768 A1
(43) Pub. Date: Oct. 29, 2026

(54) USING A MICROBIAL FUEL CELL AND ELECTROCHEMICAL REACTOR SYSTEM FOR WASTEWATER TREATMENT AND CARBON DIOXIDE REDUCTION

(71) Applicants: Saudi Arabian Oil Company, Dhahran (SA); King Abdullah University of Science and Technology, Thuwal (SA)

(72) Inventors: Hend Mohamed, Thuwal (SA); Jehad Khaled El-Demellawi, Thuwal (SA); Manal Faisal Alqahtani, Thuwal (SA); Pedro Castano, Thuwal (SA)

(21) Appl. No.: 19/227,647

(22) Filed: Jun. 4, 2025

Related U.S. Application Data
(60) Provisional application No. 63/796,871, filed on Apr. 29, 2025.

(51) Int. Cl. H01M 8/16; C02F 1/461; C02F 1/467; C02F 3/00; C25B 3/26; C25B 9/19; C25B 11/052; C25B 11/065; C25B 11/091; H01M 4/90

(52) U.S. Cl. CPC H01M 8/16; C02F 1/46109; C02F 1/4672; C02F 3/005; C25B 3/26; C25B 9/19; C25B 11/052; C25B 11/065; C25B 11/091; H01M 4/9083; C02F 2001/46142; C02F 2201/46115; C02F 2201/46165

(57) ABSTRACT

A system is provided including a microbial fuel cell (MFC) system including a MFC. The MFC includes a MFC anode chamber including a MFC anode, microorganisms, and a MFC anolyte inlcuding an organic substrate. The MFC includes a MFC cathode chamber including a MFC cathode, oxygen, and a MFC catholyte. The MFC system includes an electrochemical reactor (ECR). The ECR includes an ECR anode chamber, which includes a ECR anode and an ECR anolyte including water. The ECR includes an ECR cathode chamber, which includes a ECR cathode, an ECR catholyte, and carbon dioxide. The MFC is configured to supply a voltage to the ECR by oxidizing the organic substrate to generate oxidation products and reducing oxygen to generate water. The ECR is configured to receive the voltage via a conductor to generate reduction products by reducing carbon dioxide and to generate oxygen by oxidizing water.

### CROSS-REFERENCE TO RELATED PATENT APPLICATIONS

This application claims the benefit of U.S. Provisional Application No. 63/796,871, filed Apr. 29, 2025, the contents of which are incorporated by reference herein.

### TECHNICAL FIELD

This disclosure generally relates to wastewater treatment and carbon dioxide reduction. More specifically, embodiments of this disclosure relate to a microbial fuel cell and electrochemical reactor system for wastewater treatment and carbon dioxide reduction.

### BACKGROUND

In recent decades, carbon dioxide emissions and atmospheric concentrations have increased, with negative environmental consequences such as global warming and climate change. Mitigating these emissions through efficient wastewater treatment and CO₂ reduction is an important global objective.

### SUMMARY

The present disclosure relates to a system that includes a microbial fuel cell (MFC) and an electrochemical reactor (ECR). The present disclosure also relates to a method of using the MFC system and ECR for wastewater treatment and carbon dioxide reduction.

For example, embodiments of the present disclosure may reduce atmospheric carbon dioxide by converting carbon dioxide into valuable products (e.g., C₂₊ products such as ethylene, ethanol, etc.). The provided MFC can generate electricity, which can be used to drive the carbon dioxide reduction reaction. Reducing carbon dioxide is not spontaneous and requires a voltage of at least 1.2 V to overcome the thermodynamic energy barrier. The MFC converts organic substrates in wastewater to electricity, supplying the required voltage (≥1.2 V) to drive CO₂ reduction in the ECR. In some embodiments, the provided system is a standalone or otherwise self-contained operation. The integrated system may efficiently operates without external power sources, significantly enhancing environmental and economic benefits by producing valuable chemical products (e.g., ethylene, ethanol) and clean water.

Embodiments of the present disclosure provide a system. The system can include a MFC system that includes a MFC. The MFC can includes a MFC anode chamber. The MFC anode chamber includes a MFC anode, microorganisms, and a MFC anolyte comprising an organic substrate. The MFC includes a MFC cathode chamber. The MFC cathode chamber includes a MFC cathode, oxygen, and a MFC catholyte. The MFC includes a MFC ion selective membrane configured between the MFC anode chamber and the MFC cathode chamber. The system includes an electrochemical reactor (ECR). The ECR includes an ECR anode chamber. The ECR anode chamber includes a ECR anode and an ECR anolyte comprising water. The ECR includes an ECR cathode chamber. The ECR cathode chamber includes a ECR cathode, an ECR catholyte, and carbon dioxide. The ECR includes a ECR ion selective membrane configured between the ECR anode chamber and the ECR cathode chamber. The MFC is configured to supply a voltage to the ECR via a conductor by oxidizing the organic substrate to generate oxidation products at the MFC anode and reducing oxygen at the MFC cathode to generate water. The voltage can be greater than 1.2 V. The ECR is configured to receive the voltage via a conductor to generate reduction products by reducing carbon dioxide at the ECR cathode and to generate oxygen by oxidizing water at the ECR anode.

The details of one or more implementations of the subject matter of this specification are outlined in the Detailed Description, the accompanying drawings, and the claims. Other features, aspects, and advantages of the subject matter will become apparent from the Detailed Description, the claims, and the accompanying drawings.

### DESCRIPTION OF THE DRAWINGS

FIG. 1 is a schematic drawing of a system with a microbial fuel cell and an electrochemical reactor, according to an embodiment of the present disclosure.

FIG. 2 is a schematic drawing of the microbial fuel cell of FIG. 1 according to an embodiment of the present disclosure.

FIG. 3 is a flow chart illustrating a method according to an embodiment of the present disclosure.

Like reference numbers and designations in the various drawings indicate like elements.

### DETAILED DESCRIPTION

The present disclosure relates to a system that includes a microbial fuel cell (MFC) and an electrochemical reactor (ECR). The present disclosure also relates to a method of using the MFC system and ECR for wastewater treatment and carbon dioxide reduction.

For example, embodiments of the present disclosure may reduce atmospheric carbon dioxide by converting carbon dioxide into valuable products (e.g., C₂₊ products such as ethylene, ethanol, etc.). The provided MFC can generate electricity, which can be used to drive the carbon dioxide reduction reaction. Reducing carbon dioxide is not spontaneous and requires a voltage of at least 1.2 V to overcome the thermodynamic energy barrier. The provided MFC can generate enough voltage to reduce carbon dioxide in the ECR while also treating wastewater. In some embodiments, the provided system is a standalone or otherwise self-contained operation. The MFC can generate enough voltage to reduce carbon dioxide without additional external energy input(s). The dual functionality of treating wastewater while lowering carbon dioxide provides substantial economic and environmental benefits.

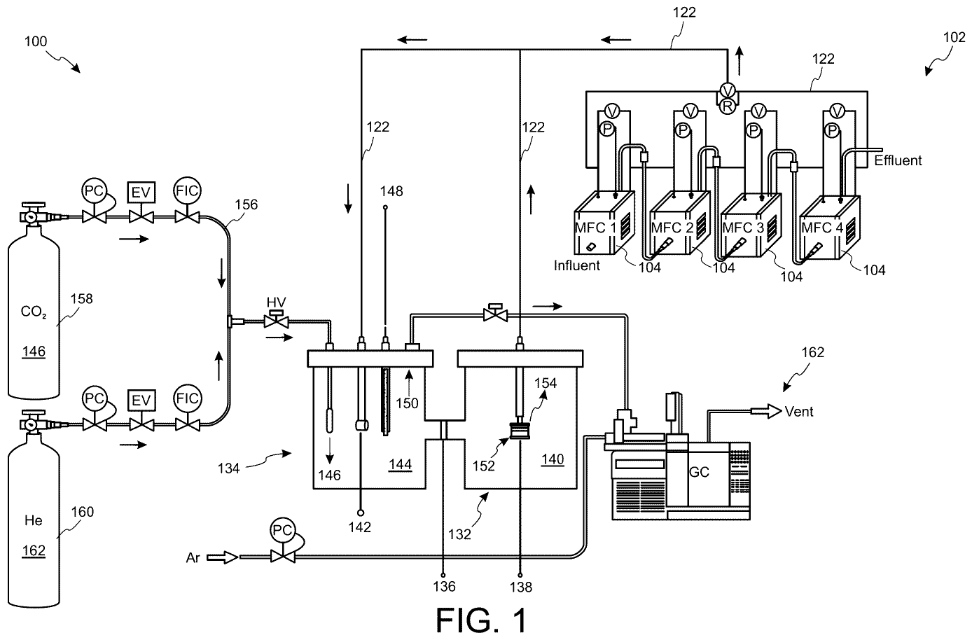

Referring to FIG. 1, a system 100 is illustrated according to some embodiments of the present disclosure. In general, the system 100 includes a MFC system 102 and an ECR 130. The MFC system 102 can include a MFC 104 or multiple MFCs 104 arranged in series, parallel, or a combination.

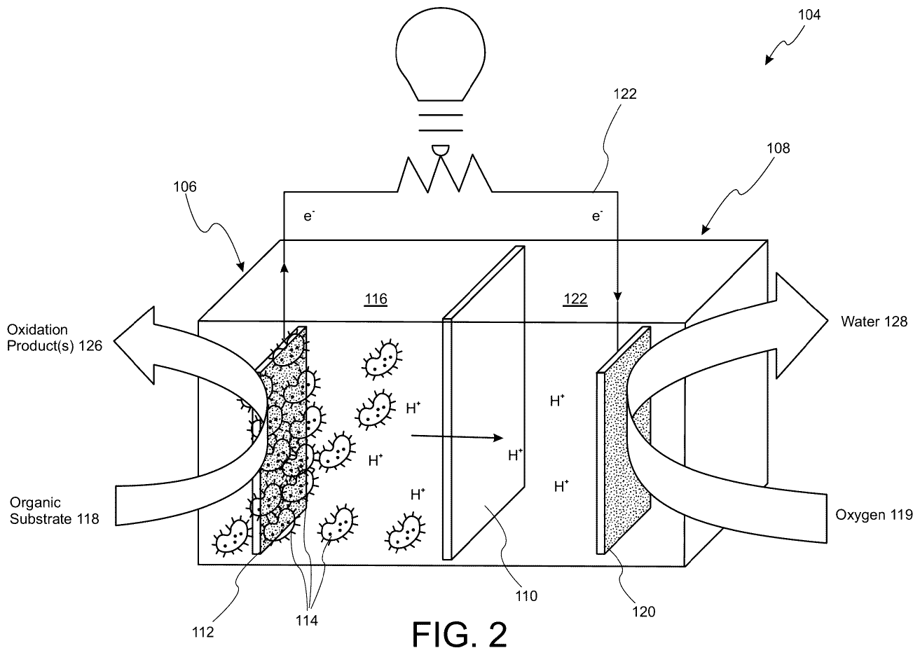

Referring to FIG. 2, a perspective view of the MFC 104 is illustrated, showing the interior components of the MFC 104. The MFC 104 includes an MFC anode chamber 106, a MFC cathode chamber 108, and a MFC ion-selective membrane 110 configured between the MFC anode chamber 106 and the MFC cathode chamber 108. In some embodiments the MFC ion selective membrane 110 allows the passage of hydrogen ions from the MFC anode chamber 106 to the MFC cathode chamber 108. In some embodiments, the MFC ion selective membrane 110 is a perfluorosulfonic acid polymer (e.g., Nafion™ manufactured by The Chemours Company).

The MFC anode chamber 106 includes a MFC anode 112, microorganisms 114, and an MFC anolyte 116 that includes an organic substrate 118. The MCF cathode chamber 108 includes a MFC cathode 120, a MFC catholyte 122, and oxygen 124. In use, the microorganisms 114 in the MFC anode chamber 106 can oxidize the organic substrate 118 in the MFC anolyte 116 to produce oxidation products 126, hydrogen ions (H⁺) and electrons. The electrons released by the oxidation reaction are transferred from the MFC anode 112 to a MFC cathode 120 in the MFC cathode chamber 108 by a conductor 122, while the hydrogen ions pass from the MFC anode chamber 106 through the MFC ion selective membrane 110 to the MFC cathode chamber 108 to balance the charge. In the cathode chamber 108, oxygen 119 is reduced at the MFC cathode 120 to generate water 128.

In some embodiments, the MFC anode 112 comprises a carbon support. Suitable carbon supports can include, but are not limited to, carbon cloth, carbon paper, or combinations thereof. In some embodiments, the MFC anode 112 comprises a carbon support coated with Ti₃C₂Tₓ or delaminated Ti₃C₂Tₓ. In some embodiments, T is selected from the group consisting of fluorine, oxygen, hydroxide, chlorine, bromine, iodine, or combinations thereof. In some embodiments, x is a number to satisfy the valence state of the delaminated Ti₃C₂Tₓ. In some embodiments, “delaminated” Ti₃C₂Tₓ refers to a process where the multilayered structure of Ti₃C₂Tₓ, a two-dimensional material known as MXene, is separated into individual, thin layers. This delamination process aims to enhance the material's properties, particularly surface area and electrochemical performance. Delaminated Ti₃C₂Tₓ may be obtained through chemical intercalation (e.g., with dimethyl sulfoxide or tetramethylammonium hydroxide), where large organic molecules are inserted between layers, widening the interlayer spacing and reducing the attraction between them. Other methods may include, for example, flash freezing or sonication, which can induce layer separation. Without wishing to be bound to a particular theory, it is contemplated herein that MFC anodes 112 containing delaminated Ti₃C₂Tₓ can increase voltage output (e.g., a voltage of at least 1.2 V) and current densities (e.g., up to 15 A/m² using about 80 mL of wastewater) from the MFC system 102 compared to MFC anodes 112 without delaminated Ti₃C₂Tₓ. In some embodiments, the MFC anode 112 can generate a current density from 10 to 15 A/m².

In some embodiments, the microorganisms 114 include electroactive bacteria or exoelectrogenic microorganisms. Suitable microorganisms 114 can include, but are not limited to, Shewanella oneidensis, Sheanella putrefaciens, Pseudomonas alcaliphilia, Pseudomonas aeruginosa, Aeromonas hydrophilia, Geobacter metaillreducens, Geobacter sulfurreducens, or combinations thereof. In some embodiments, electron transfer from the microorganism to the MFC anode 112 is facilitated by a mediator, such as thionine, pyocyanin, methyl viologen, methyl blue, humic acid, neutral red, or combinations thereof. In some embodiments, the anode chamber 106 is mediator-free, where the microorganism 114, such as Shewanella putrefaciens or Aeromonas hydrophila, can transfer electrons to the electrode without a mediator.

In some embodiments, the MFC anolyte 116 can be wastewater. The MFC anolyte 116 can include, but is not limited to, industrial wastewater, agricultural wastewater, sewage (e.g., domestic wastewater or municipal wastewater), surface runoff, urban runoff, or combinations thereof. The organic substrates 118 present in the MFC anolyte 116 can include, but are not limited to, glucose, acetate, lactose, pyruvate, lactase, or combinations thereof.

In some embodiments, the MFC cathode 120 comprises a carbon support. Suitable carbon supports can include, but are not limited to, carbon paper, carbon cloth, or combinations thereof. In some embodiments, the carbon support is loaded with platinum (e.g., platinum is dispersed throughout at least a portion of the carbon support). In some embodiments, the platinum is present in an amount from 0.1 to 3 mg/cm² in the carbon support. In some embodiments, the platinum is present in an amount of at least 0.1 mg/cm² (e.g., at least 0.2 mg/cm², at least 0.3 mg/cm², at least 0.4 mg/cm², at least 0.5 mg/cm², at least 1 mg/cm²) and/or at most 3 mg/cm² (e.g., at most 2.5 mg/cm², at most 2 mg/cm², at most 1.5 mg/cm²).

In some embodiments, the MFC catholyte 122 includes water and an electron acceptor. In some embodiments, the electron acceptor is oxygen 119. In use, the oxygen 119 is reduced at the MFC cathode 120 to generate water 128. The oxygen 119 can be introduced into the MFC cathode chamber 108 in any suitable manner. For example, the oxygen 119 may be dissolved in the MFC catholyte 122. In another example, the oxygen 118 may be bubbled or flowed through the MFC catholyte 122. Alternatively, the MFC cathode 120 and/or the MFC catholyte 122 may be exposed to air by an opening the MFC cathode chamber 108 for oxygen 119 to diffuse into the MFC catholyte 122. The MFC catholyte 122 may also include salts, which can include, but are not limited to, ferricyanide, phosphate buffer (K₂HPO₄), potassium permanganate, potassium dichromate, sodium chloride, potassium chloride, sodium sulfate, or combinations thereof.

In some embodiments, the MFC system 102 generates a voltage greater than 1.2 V. The voltage generated by the MFC system 102 can be sufficient to drive the reduction of carbon dioxide in the ECR 130 without any additional, external power supply. In some embodiments, the MFC system 102 generates a voltage from 1.2 to 3.5 V. In some embodiments, the MFC system 102 generates a voltage from at least 1.2 V (e.g., at least 1.3 V, at least 1.4 V, at least 1.5 V) and/or to at most 3.5V (e.g., at most 3 V, at most 2.5 V, at most 2 V, at most 1.9 V, at most 1.8V, at most 1.7 V, at most 1.6 V). In some embodiments, the MFC system 102 generates a current density from 10 A/m² to 15 A/m². In some embodiments, the MFC system 102 generates a current density of at least 10 A/m² (e.g., at least 10.5 A/m², at least 11 A/m², at least 11.5 A/m², at least 12 A/m², at least 12.5 A/m²) and/or at most 15 A/m² (e.g., at most 14.5 A/m², at most 14 A/m², at most 13.5 A/m², at most 13 A/m²). In some embodiments, the voltage and current density may be generated in the MFC 104 using small volumes of wastewater (e.g., at least 80 mL of wastewater).

Referring back to FIG. 1, the MFC system 102 includes multiple MFCs 104 arranged in series. In the illustrated embodiment, the MFC anolyte 116 comprising the organic substrate 118 (e.g., wastewater) is fed to an inlet of a first MFC 104 in the series as an influent, which may exit the first MFC 104 in the series as a first effluent. The first effluent exiting the first MFC 104 is discharged to an inlet of a second MFC 104, which may exit the second MFC 104 as a second effluent. The second effluent exiting the second MFC 104 is discharged to an inlet of a third MFC 104, which may exit the third MFC 104 as a third effluent. The third effluent is discharged to an inlet of the fourth MFC 104, which may exit the fourth MFC 104 as a fourth effluent. Although not shown in FIG. 1, this process may be repeated any number of times to generate treated wastewater in the effluent. For example, the last effluent in the series may be in fluid communication with an N^{th} MFC 104, where N represents the final MFC 104 in the series. In some embodiments, N is at least 2 (e.g., at least 3, at least 4, at least 5, at least 10, at least 50, at least 100, at least 1000, etc.).

In the illustrated embodiments, the voltage generated from the MFC system 102 is supplied to the ECR 130 via a conductor 122. The ECR 130 includes an ECR anode chamber 132, an ECR cathode chamber 134, and an ECR ion selective membrane 136 configured between the ECR anode chamber 132 and the ECR cathode chamber 134. In some embodiments, the ECR ion selective membrane 136 may allow the passage of hydrogen ions from the ECR anode chamber 132 to the ECR cathode chamber 134. In some embodiments, the ECR ion selective membrane 136 is a perfluorosulfonic acid polymer (e.g., Nafion™ manufactured by The Chemours Company).

The ECR anode chamber 132 includes an ECR anode 138 and an ECR anolyte 140. In some embodiments, the ECR anolyte 140 includes water. The ECR anolyte 140 may further include salts, which can include, but are not limited to, alkaline electrolytes (e.g., potassium hydroxide, sodium hydroxide), neutral/bicarbonate electrolytes (potassium hydrogen carbonate, a bicarbonate solution), or combinations thereof. The ECR cathode chamber 134 includes an ECR cathode 142, an ECR catholyte 144, and carbon dioxide 146. In some embodiments, the ECR cathode chamber 134 includes a reference electrode 148. In some embodiments, the ECR catholyte 144 includes water. The ECR catholyte 144 can include salts. The salts in the ECR catholyte 144 can include, but are not limited to, potassium hydrogen carbonate, potassium bicarbonate, potassium hydroxide, or combinations thereof.

In use, the ECR 130 is configured to receive the voltage from the MFC system 102 via the conductor 122. The voltage initiates oxidation of water 152 in the ECR catholyte 144 to generate oxygen 154, hydrogen ions, and electrons. The electrons released by the oxidation reaction are transferred from the ECR anode 138 to the ECR cathode 142, while hydrogen ions pass from the ECR anode chamber 132 through the ECR ion selective membrane 136 to the ECR cathode chamber 134 to balance the charge. In the ECR cathode chamber 134, carbon dioxide 146 is reduced at the ECR cathode 142 to generate reduction products 150. In some embodiments, the reduction products 150 include C₂₊ products. In some embodiments, the C₂₊ products include, but are not limited to, ethylene, ethanol, acetate, propanol, acetone, butanol, or combinations thereof. The reduction products 150 may also include C₁ products, which can include, but are not limited to, methane, carbon monoxide, formate, or combinations thereof. In some embodiments, the C₂₊ products have at least a 65% yield and/or selectivity in the reduction products 150.

In some embodiments, the ECR anode 138 comprises a carbon support. In some embodiments, the carbon support comprises carbon cloth, carbon paper, or combinations thereof. In some embodiments, the carbon support is loaded with platinum (e.g., platinum is dispersed throughout at least a portion of the carbon support). In some embodiments, the platinum is present in an amount from 0.1 to 3 mg/cm² in the carbon support. In some embodiments, the platinum is present in an amount of at least 0.1 mg/cm² (e.g., at least 0.2 mg/cm², at least 0.3 mg/cm², at least 0.4 mg/cm², at least 0.5 mg/cm², at least 1 mg/cm²) and/or at most 3 mg/cm² (e.g., at most 2.5 mg/cm², at most 2 mg/cm², at most 1.5 mg/cm²).

In some embodiments, the ECR cathode 142 comprises a carbon support. In some embodiments, the carbon support comprises carbon cloth, carbon paper, or combinations thereof. In some embodiments, the carbon support has a coating. In some embodiments, the coating comprises a copper oxide. In some embodiments, the copper oxide is doped with cerium oxide. In some embodiments, the cerium oxide is present in the coating in an amount from 0.1 to 10 wt. %, based on the total weight of the coating. In some embodiments, the cerium oxide is present in an amount of at least 0.1 wt. % (e.g., at least 0.5 wt. %, at least 1 wt. %, at least 1.5 wt. %, at least 2 wt. %, at least 3 wt. %, at least 4 wt. %) and/or at most 10 wt. % (e.g., at most 9 wt. %, at most 8 wt. %, at most 7 wt. %, at most 6 wt. %, at most 5 wt. %). Without wishing to be bound to a particular theory, it is contemplated herein that the provided ECR cathode 142, containing copper oxide and/or copper oxide doped with cerium oxide, can improve selectivity and yield of C₂₊ products as compared to a cathode without copper oxide and/or copper oxide doped with cerium oxide.

A conduit 156 places a carbon dioxide source 158 providing the carbon dioxide 146 in fluid communication with the ECR cathode chamber 134. The conduit 156 places a diluent source 160 comprising a diluent 162 in fluid communication with the ECR cathode chamber 134. The diluent 162 may be mixed with carbon dioxide 146 in conduits 156 before being delivered to the ECR cathode chamber 134. In some embodiments, the conduit 156 includes one or more of a pressure controller valve (PC), an electronic valve (EV), mass flow controller (FIC), hand valve (HV), or combinations thereof to regulate the flow of the carbon dioxide 146 and diluent 162 to the ECR cathode chamber 134. The ECR cathode chamber 134 may include an inlet that receives the carbon dioxide 146 and the diluent 162. The ECR cathode chamber 134 may include an outlet that allows the reduction products 150 to be sent to a separator 162. In some embodiments, the separator 164 includes a gas chromatograph that is configured to separate the reduction products 150. In some embodiments, a conduit 166 places a carrier gas 168 (e.g., Ar) in fluid communication with the separator 164, which transports the reduction products 150 through a column in the separator 164 for separation.

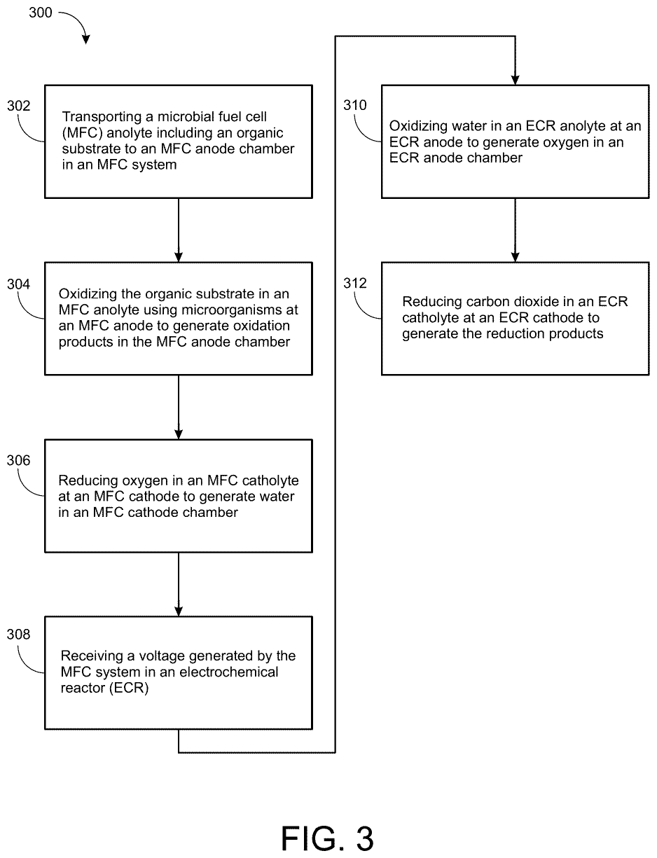

Referring to FIG. 3, a method 300 is illustrated according to embodiments of the present disclosure. At operation 302, the method 300 includes transporting the MFC anolyte 116 comprising the organic substrate 118 to the MFC anode chamber 106 in an MFC system 102. In some embodiments, the MFC anolyte 116 is transported to the MFC anode chamber 106 using a pump. At operation 304, the method 300 includes oxidizing the organic substrate 118 in the MFC anolyte 116 using the microorganisms 114 at the MFC anode 112 to generate oxidation products 126 in the MFC anode chamber 106. At operation 306, the method 300 reduces oxygen 119 in the MFC catholyte 112 to generate water 128 in the MFC cathode chamber 108. Operations 302-306 may generate a voltage of at least 1.2 V.

At operation 308, the method 300 includes receiving the voltage generated by the MFC system 100 in the ECR 130. The conductor 122 may place the MFC in electrical communication with the ECR 130. At operation 310, the method 300 includes oxidizing water 152 in the ECR anolyte 140 at an ECR anode 138 to generate oxygen 154 in the ECR anode chamber 132. At operation 312, the method 300 includes reducing carbon dioxide 146 at the ECR cathode 142 to create the reduction products 150.

What is claimed is:

1. A system comprising:
a microbial fuel cell (MFC) system including a MFC, the MFC comprising:
a MFC anode chamber including a MFC anode, microorganisms, and a MFC anolyte comprising an organic substrate;
a MFC cathode chamber including a MFC cathode, oxygen, and a MFC catholyte;
a MFC ion-selective membrane configured between the MFC anode chamber and the MFC cathode chamber;
an electrochemical reactor (ECR) comprising:
an ECR anode chamber including an ECR anode and an ECR anolyte comprising water;
an ECR cathode chamber including an ECR cathode, an ECR catholyte, and carbon dioxide;
a ECR ion-selective membrane configured between the ECR anode chamber and the ECR cathode chamber; and
wherein the MFC is configured to supply a voltage to the ECR via a conductor by oxidizing the organic substrate to generate oxidation products at the MFC anode and reducing oxygen at the MFC cathode to generate water;
wherein the voltage is greater than 1.2 V; and
wherein the ECR is configured to receive the voltage via a conductor to generate reduction products by reducing carbon dioxide at the ECR cathode and to generate oxygen by oxidizing water at the ECR anode.

2. The system of claim 1, wherein the voltage is from 1.2 V to 3.5 V.

3. The system of claim 1, wherein the MFC is configured to supply a current density to the ECR from 10 A/m² to 15 A/m².

4. The system of claim 1, wherein the MFC anode comprises a carbon support coated with a delaminated Ti₃C₂Tₓ;
wherein T is selected from the group consisting of fluorine, oxygen, hydroxide, chlorine, bromine, iodine, or combinations thereof; and
wherein x is a number to satisfy the valence state of the delaminated Ti₃C₂Tₓ.

5. The system of claim 1, wherein the MFC cathode comprises a carbon support loaded with platinum.

6. The system of claim 5, wherein the platinum is present within the MFC cathode in an amount from 0.1 to 3 mg/cm².

7. The system of claim 1, wherein the ECR anode comprises a carbon support loaded with platinum.

8. The system of claim 7, wherein the platinum is present in the ECR anode in an amount from 0.1 to 3 mg/cm².

9. The system of claim 1, wherein the ECR cathode comprises a carbon support having a coating disposed on the carbon support, wherein the coating comprises a copper oxide.

10. The system of claim 9, wherein the copper oxide is doped with cerium oxide, and wherein the cerium oxide is present in the coating in an amount from 0.1 to 10 wt. %, based on a total weight of the coating.

11. The system of claim 1, wherein the MFC anolyte comprises wastewater.

12. The system of claim 1, wherein the reduction products in the ECR cathode chamber comprise C₂₊ products.

13. The system of claim 1, wherein the MFC system comprises a plurality of MFCs configured in series, parallel, or a combination thereof.

14. A method comprising:
transporting a microbial fuel cell (MFC) anolyte comprising an organic substrate to an MFC anode chamber in an MFC system, the MFC system comprising a MFC cathode chamber and a MFC ion-selective membrane configured between the MFC anode chamber and the MFC cathode chamber;
oxidizing the organic substrate in an MFC anolyte using microorganisms at an MFC anode to generate oxidation products in the MFC anode chamber;
reducing oxygen in an MFC catholyte at an MFC cathode to generate water in the MFC cathode chamber, wherein the MFC system generates a voltage greater than 1.2 V;
receiving the voltage in an electrochemical reactor (ECR) via a conductor to generate reduction products, the ECR comprising an ECR anode chamber, an ECR cathode chamber, and an ECR ion-selective membrane configured between the ECR anode chamber and the ECR cathode chamber;
oxidizing water in an ECR anolyte at an ECR anode to generate oxygen in the ECR anode chamber; and
reducing carbon dioxide in an ECR catholyte at an ECR cathode to generate the reduction products.

15. The method of claim 14, wherein the voltage is from 1.2 V to 3.5 V.

16. The method of claim 14, wherein the MFC anode comprises a carbon support coated with a delaminated Ti₃C₂Tₓ;
wherein T is selected from the group consisting of fluorine, oxygen, hydroxide, chlorine, bromine, iodine, or combinations thereof; and
wherein x is a number to satisfy the valence state of the delaminated Ti₃C₂Tₓ.

17. The method of claim 14, wherein the ECR cathode comprises a carbon support having a coating disposed on the carbon support;
wherein the coating comprises a copper oxide;
wherein the copper oxide is doped with cerium oxide; and
wherein the cerium oxide is present in the coating in an amount from 0.1 to 10 wt. %, based on a total weigh of the coating.

18. The method of claim 14, wherein the reduction products in the ECR cathode chamber comprise C₂₊ products.

19. The method of claim 18, wherein generating the reduction products includes generating C₂₊ products with at least 65% yield.
